(19) United States
(12) Patent Application Publication
(10) Pub. No.: US 2010/0236074 A1
(43) Pub. Date: Sep. 23, 2010

(54) CORN STRIPPER

(75) Inventor: Heather Curtin, Duarte, CA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORPORATION, Kent, WA (US)

(21) Appl. No.: 12/722,301

(22) Filed: Mar. 11, 2010

Related U.S. Application Data
(60) Provisional application No. 61/162,076, filed on Mar. 20, 2009.

(51) Int. Cl. A47J 17/02; B26B 11/00

(52) U.S. Cl. 30/121.5; 30/123

(57) ABSTRACT

A corn stripper includes a handle and a tool head, the curved tool head having a curved blade and a brush. In the exemplary version, the tool head includes a blade with a sharpened edge that is generally orthogonal to the handle axis, rather than generally in line with the handle axis. Accordingly, in use the device is moved in a direction orthogonal to the handle rather than generally parallel to the handle.

### PRIORITY CLAIM

This application claims the benefit of prior U.S. provisional application Ser. No. 61/162,076, filed Mar. 20, 2009 and incorporated by reference.

### FIELD OF THE INVENTION

This invention relates generally to kitchen tools, particularly including devices for removing kernels of corn from a cob.

### BACKGROUND OF THE INVENTION

Preparing raw corn for cooking can be a time consuming and messy process. Currently, many people remove corn from a cob by using a knife, which slices through many or most of the kernels in the process. Other products have been designed specifically for removal of corn kernels, but each is less than satisfactory in one regard or another.

There are a variety of products that have been developed in an effort to solve this long felt need. Some devices are more concerned with slitting open the kernels of corn while removing them from the cob. For example, U.S. Pat. No. 5,438,760 to Charlier is directed to a corn slitter that includes a handle with a curved tool head and a plurality of teeth on the tool head. The tool head is forced longitudinally along the cob in the direction of the axis of the handle, with the teeth abrading the kernels as they are separated.

U.S. Pat. No. 2,412,149 to Higgins is similar in configuration, with a curved tool head extending longitudinally from an angled handle. In each case, the cutting action is generally in the direction of the handle axis.

U.S. Pat. No. 2,173,751 to Burkhart illustrates yet another corn slicer of the type having a tool head extending longitudinally from an angularly offset handle. In the case of the Burkhart patent, the tool head includes blades carried on a frame with a gap between the blades.

Another patent, U.S. Pat. No. 1,414,372 to Olcott, depicts an earlier version of this same type of device in which the tool must be pushed in a direction generally in line with the longitudinal axis of the handle. An even earlier patent, U.S. Pat. No. 935,517 to Johnson, presents a device that is much the same but in which the handle is pulled in a longitudinal direction rather than pushed.

More recently, U.S. Patent Publication 2006/0288582 to Settele describes a corn scraper having an elongate handle and a tool head with a “bridge member” connected to a base plate. The bridge member includes a “tooth means” for engagement with the corn. This arrangement is substantially the same as the Burkhart device, with a blade extending across a frame to form a bridge. The longitudinal axis of the handle is described as being offset from the longitudinal axis of the tool head, much the same way as the angled offset handles of the above prior devices. One problem with the Settele device and each of the earlier described devices is that the corn must pass through the blade or “bridge member” longitudinally, in the direction of the axis of the handle. This places the handle in the way of the cob as slicing through the corn. The prior devices collectively teach that this problem can be overcome by introducing an angle between the tool head and the handle, or by longitudinally offsetting the handle from the tool head to some extent. This adjustment has not produced an effective device, and also makes for an awkward gripping action when removing kernels.

Accordingly, there is a long felt but unresolved need for an improved device to remove kernels from a cob of corn.

### SUMMARY OF THE INVENTION

The corn stripper in accordance with the present invention includes a handle and a tool head, the tool head having a blade and a brush. In the exemplary version, the tool head includes a blade with a sharpened edge that is generally orthogonal to the handle axis, rather than generally in line with the handle axis. Accordingly, in use the device is moved in a direction orthogonal to the handle rather than generally parallel to the handle.

In accordance with a preferred version, the blade includes a first end and a second end, the first end and second ends of the blade being secured to the tool head in a longitudinal fashion such that the blade is generally parallel with the handle. The blade may optionally include three sections, including a first substantially straight section adjacent the first end of the tool head, a second substantially straight section adjacent the second end of the tool head, and a central curved section between the two substantially straight sections. The central curved section is spaced apart from the curved tool head by a distance forming a gap between the blade and the tool head that is sufficiently large to allow corn kernels to pass through the gap.

The exemplary tool head further includes a brush formed from a plurality of bristles. In a preferred version, the bristles are formed from sections of thin plastic, though other materials such as food grade silicone may be used instead.

The bristles form a brush that is secured to the tool head at a location generally opposite that of the blade. In use, the brush is suitable for brushing away silk or other undesired particles.

These and other aspects of various examples of the invention will be described in further detail below.

### BRIEF DESCRIPTION OF THE DRAWINGS

Preferred and alternative examples of the present invention are described in detail below with reference to the following drawings:

FIG. 1 is a perspective view of a preferred corn stripper.

FIG. 2 is a left side view of the corn stripper of FIG. 1.

FIG. 3 is a front view of the corn stripper of FIG. 1.

FIG. 4 is a right side view of the corn stripper of FIG. 1.

FIG. 5 is a front view of the corn stripper of FIG. 1.

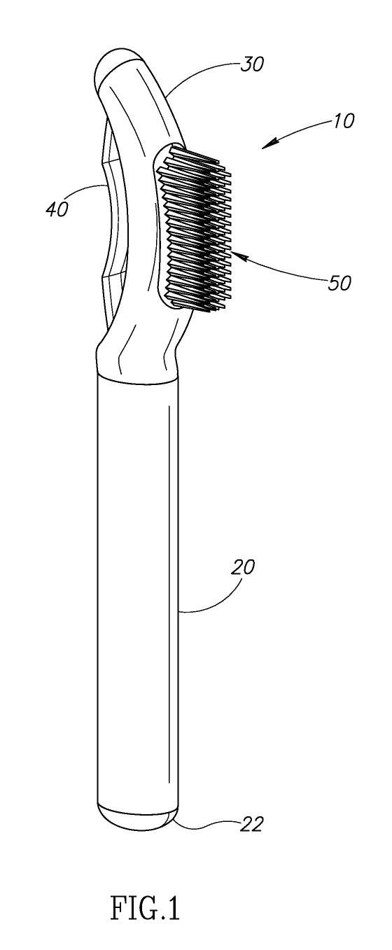

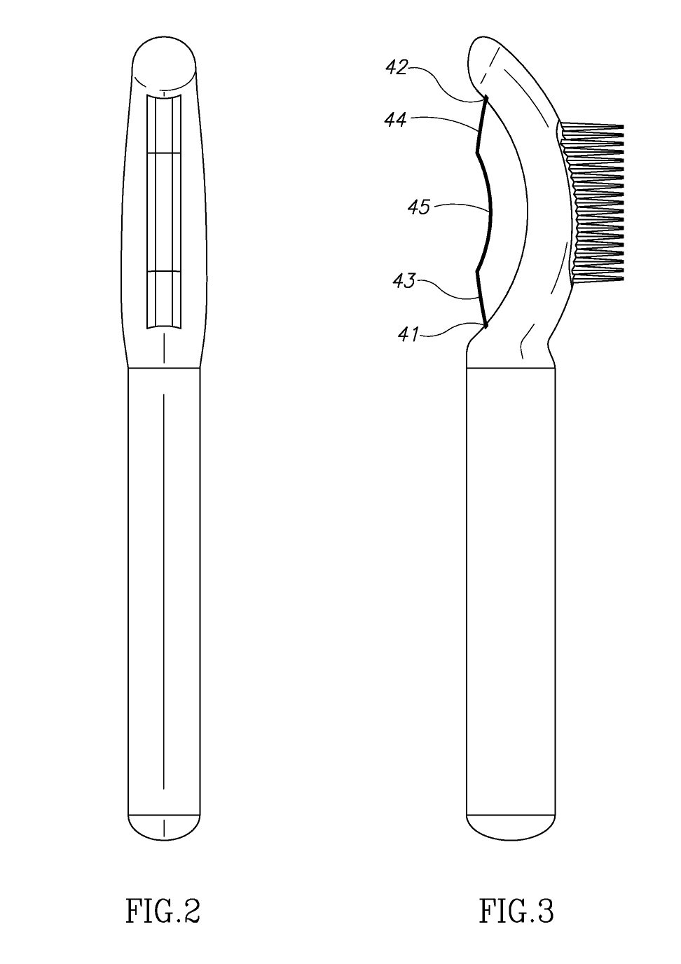

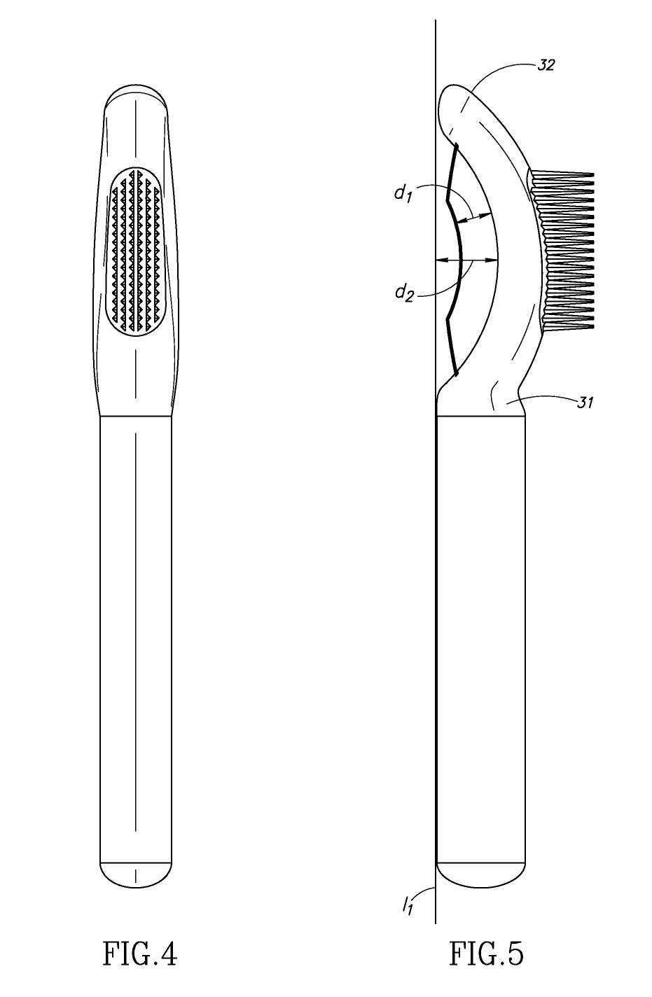

### DETAILED DESCRIPTION OF THE PREFERRED EMBODIMENT

With reference to the figures, the preferred version of the corn stripper 10 includes a handle 20 and a tool head 30, the tool head having a blade 40 and a brush 50. In the illustrated example, the handle is formed from stainless steel and is generally cylindrical in shape, terminating in an end cap 22. In other versions, the handle may have any shape suitable for grasping by a user, and may be formed from other materials such as plastic or wood. Likewise, the handle may include an over-molded grip formed of resilient materials such as rubber or santoprene.

The tool head 30 is attached to the handle opposite the end cap. In the illustrated example, the tool head is formed from plastic and therefore the tool head and the handle are configured as two separate components that are secured to one another. In other versions, the tool head and handle may be integrally formed, for example from plastic.

The tool head is curved in shape, preferably following a path from a first end 31 adjacent the handle and terminating at a second distal end 32. In one version, the arc of curvature of the tool head may follow a path defined as a segment of a circle, though in the version as illustrated the arc is closer to an oval segment than a circular segment. The first end of the tool head begins adjacent a line l₁, the line l₁ preferably being substantially parallel to an axis defined by the length of the handle. In other versions, the line l₁ may be tangential to a point at the first end 31 and second end 32 of the tool head. As the tool head curves away from the line at the first end 31 it ultimately terminates again adjacent the line l₁ at the second end 32. Thus, in the preferred version the line l₁ extends axially from the handle and is tangential to or passes through the first and second ends of the tool head. The tool head curvature forms a depth d₂, defined as the distance between the line l₁ and the deepest point of curvature of the tool head. The tool head may also be described as forming a shallow U-shape as it extends from the first end 31 to the second end 32 of the tool head.

The blade 40 includes a first end 41 and a second end 42, the first end and second end of the blade being secured to the first end and second end of the tool head, respectively. The blade is comprised of three sections, including a first substantially straight section 43 adjacent the first end of the tool head, a second substantially straight section 44 adjacent the second end of the tool head, and a central curved section 45 between the two substantially straight sections. The central curved section is spaced apart from the curved tool head by a distance d₁, the distance d₁ forming a gap between the blade and the tool head that is sufficiently large to allow corn kernels to pass through the gap. Thus, the blade and the tool head are each curved along a substantially similar path to form a substantially uniform and curved gap between the blade and the tool head at least along the curved section of the blade.

The blade is secured to the tool head such that the blade is preferably fully within the region defined by the line lₗ and the interior surface of the tool head arc. The blade is further secured to the tool head at locations that are substantially equidistant from the line l₁, such that the blade extends in a direction from the first end 41 to the second end 42 in a direction that is generally parallel to the line l₁ and also parallel with a central axis extending through the handle.

In other versions of the invention, the blade may be formed as an arc without the accompanying substantially straight sections, as shown. In such a version, the handle may include extensions to separate the blade from the tool head, thereby forming the gap between the blade and the tool head while securing the blade to the tool head. In one such version, the extensions may be shaped substantially the same as the substantially straight blade segments, except that they are not formed and sharpened as blades.

In a preferred example, the blade is formed from stainless steel, though in other versions the blade may be formed form other metals, plastic, or other materials.

The tool head further includes a brush 50 formed from a plurality of bristles.

In a preferred version, the bristles are formed from sections of thin plastic, though other materials such as food grade silicone may be used instead.

As shown, the bristles form a brush that is secured to the tool head at a location generally opposite that of the blade 40. Thus, while the blade is attached to the tool head on the interior surface of the curved tool head, the brush is attached to the tool head at the exterior surface of the tool head.

In other examples of the invention, the brush may be located at any location on the tool head, such as at the tip of the tool head. In such a configuration, the brush may extend generally axially away from the tool head, for example. In yet another example of the invention, the brush may be located on the tool adjacent the first end of the handle, forming a tool having a tool head and blade at one end of the handle and a brush at the opposite end of the handle.

In use, the husk from an ear of corn is removed, leaving the kernels exposed. The brush is used to whisk away any remaining silk to produce a corn cob with kernels attached but with no husk or silk. Then the tool head is placed at one end of the ear of corn such that blade is adjacent the cob and the kernels are within the gap between the blade and the tool head. By urging the tool downward, the blade cuts the kernels away from the cob, with the kernels passing through the gap. The process is repeated as necessary to separate all of the corn from the cob.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A corn stripper, comprising:
a handle having a first end and a second end;
a tool head extending axially away from the second end of the handle, the tool head having a proximal end adjacent the handle and a distal end distant from the handle, the tool head following a path of curvature as it extends from the proximal end to the distal end; and
a blade mounted on the tool head, the blade having a first end attached relatively adjacent the proximal end of the tool head and a second end attached relatively adjacent the distal end of the tool head, the blade having a curved section and being mounted on the tool head to define a substantially uniform gap between the blade and the tool head along the length of the curved section, whereby when in use kernels of corn may be separated from a cob by the blade and pass through the gap.

2. The corn stripper of claim 1, further comprising a brush attached to the tool head.

3. The corn stripper of claim 2, wherein the brush is attached to the tool head in a position substantially opposite the blade.

4. The corn stripper of claim 1, wherein the handle extends parallel to a line passing through the distal end of the tool head and the proximal end of the tool head, the path of curvature of the tool head defining a distance between the line and a deepest point of curvature of the tool head.

5. The corn stripper of claim 1, wherein the blade further comprises a sharpened edge, the sharpened edge facing substantially orthogonal to the line.

6. The corn stripper of claim 4, wherein the blade further comprises a first straight section and a second straight section, the curved section being interposed between the first straight section and the second straight section.

7. The corn stripper of claim 1, wherein the handle extends parallel to a line passing tangential to the distal end of the tool head and to the proximal end of the tool head, the path of curvature of the tool head defining a distance between the line and a deepest point of curvature of the tool head, the distance being greater than the gap.

8. The corn stripper of claim 6, wherein the blade further comprises a first straight section and a second straight section, the curved section being interposed between the first straight section and the second straight section.

9. A corn stripper, comprising:
a handle having a first end and a second end and defining a handle axis generally in a direction from the first end to the second end;
a tool head extending axially away from the second end of the handle, the tool head having a proximal end adjacent the handle and a distal end distant from the handle, the tool head following a path of curvature as it extends from the proximal end to the distal end; and
a blade mounted on the tool head, the blade having a first end attached relatively adjacent the proximal end of the tool head and a second end attached relatively adjacent the distal end of the tool head, the blade having a curved section and being mounted on the tool head to define a gap between the blade and the tool head along the length of the curved section, the blade further having a sharpened edge facing in a direction generally orthogonal to the handle axis, whereby when in use kernels of corn may be separated from a cob by the blade and pass through the gap.

10. The corn stripper of claim 9, wherein the gap is substantially uniform along the length of the curved section of the blade.

11. The corn stripper of claim 10, further comprising a brush attached to the tool head.

12. The corn stripper of claim 11, wherein the brush is attached to the tool head in a position substantially opposite the blade.

13. The corn stripper of claim 11, wherein the handle extends parallel to a line passing through the distal end of the tool head and the proximal end of the tool head, the path of curvature of the tool head defining a distance between the line and a deepest point of curvature of the tool head.

14. The corn stripper of claim 9, wherein the blade further comprises a first straight section and a second straight section, the curved section being interposed between the first straight section and the second straight section.

15. The corn stripper of claim 9, wherein the handle extends parallel to a line passing tangential to the distal end of the tool head and to the proximal end of the tool head, the path of curvature of the tool head defining a distance between the line and a deepest point of curvature of the tool head, the distance being greater than the gap.

16. The corn stripper of claim 15, wherein the blade further comprises a first straight section and a second straight section, the curved section being interposed between the first straight section and the second straight section.
